(19) United States
(12) Patent Application Publication
(10) Pub. No.: US 2018/0338103 A1
(43) Pub. Date: Nov. 22, 2018

(54) SOFTWARE VIDEO COMBINER

(71) Applicant: Bell Helicopter Textron Inc., Fort Worth, TX (US)

(72) Inventors: D. Brent McCall, Keller, TX (US); Jonathan H. Rhea, North Richland Hills, TX (US); Ryan C. Rogers, Fort Worth, TX (US)

(21) Appl. No.: 15/596,469

(22) Filed: May 16, 2017

(51) Int. Cl. H04N 5/445; G09B 9/12; G09B 9/24

(52) U.S. Cl. CPC H04N 5/44504; G09B 9/24; G09B 9/12; H04N 5/44591

(57) ABSTRACT

There is disclosed in one embodiment, a software video combiner, including: a processor; a memory; a video input interface; a video output interface; and one or more logic elements including a software video combiner engine, configured to: receive a plurality of input images via the video input interface; and create a composite image from the plurality of input images, including overlaying a first image onto a second image, treating pixels of the first image of an ignored color as non-selected pixels, and outputting the composite image to a multifunction display (MFD) via the video output interface.

### TECHNICAL FIELD

This disclosure relates generally to the field of flight training, and more particularly, though not exclusively, to a software video combiner for a flight simulator.

### BACKGROUND

Rotary aircraft such as helicopters and tilt wing craft are complex and expensive machines that require a great deal of training to learn to fly properly. Thus, before the owner of such a craft is comfortable turning over a multimillion dollar machine to a new pilot, he may require the pilot to engage in extensive training. In some cases, this training may include the use of a flight simulator. Flight simulators may also be used for continued training of experienced pilots.

### SUMMARY

According to one aspect of the present disclosure, there is disclosed a software video combiner, comprising: a processor; a memory; a video input interface; a video output interface; and one or more logic elements comprising a software video combiner engine, configured to: receive a plurality of input images via the video input interface; and create a composite image from the plurality of input images, comprising overlaying a first image onto a second image, treating pixels of the first image of an ignored color as non-selected pixels, and outputting the composite image to a multifunction display (MFD) via the video output interface.

### BRIEF DESCRIPTION OF THE DRAWINGS

FIGS. 1 and 2 illustrate example aircraft in accordance with certain embodiments.

FIG. 3 is a block diagram of a flight simulator architecture according to one or more examples of the present specification.

FIG. 4 is a block diagram of a software video combiner 324 according to one or more examples of the present specification.

FIG. 5 is a block diagram of a multiplexer 504 according to one or more examples of the present specification.

FIG. 6 is a front view of a multifunction display according to one or more examples of the present specification.

FIG. 7 is a front view of an MFD illustrating display quadrants according to one or more examples of the present specification.

FIG. 8 is a front view of an MFD illustrating a foreground image overlaid on a background image according to one or more examples of the present specification.

### DETAILED DESCRIPTION

A flight simulator is a ground-based machine that seeks to emulate the behavior and experience of flying a rotary aircraft. In general, the more detailed and accurate the flight experience, the better the training. To achieve detailed and accurate flight experience, a flight simulator may provide features to emulate aircraft systems.

The simplest flight simulators are, or are very much like, a video game. A computer monitor may display various screens including computer graphics to emulate what a pilot may see through the front canopy of the aircraft, and may also emulate other features such as a heads-up display (HUD) or a multifunction display (MFD). These kinds of simple flight simulators may be useful for allowing a new pilot to gain initial familiarity with the controls and displays of the aircraft.

There are also flight simulators that provide a much more detailed experience. Higher-end flight simulators may provide not only a fully simulated cockpit, but also a pneumatically or hydraulically actuated platform that mimics the motion of the aircraft, as well as providing haptic feedback responsive to the operator's actions. These kinds of simulators provide a more true-to-life flight simulation, and better prepare the pilot for operation of a real aircraft.

One common feature of flight simulators, and in particular those that provide a richer flight-like experience, is an emulated multifunction display (MFD). The MFD is an important piece of equipment in the cockpit that provides the operator with a rich array of information. For example, the MFD may provide video from a fore or aft-mounted video camera. The MFD can also provide feeds from forward-looking infrared (FLIR), a radar system, a terrain-following navigation aid, a collision avoidance system, or many other types of video inputs. These types of video inputs may provide a background image over which a foreground image may be superimposed. The foreground image may provide a suite of contextual information about the background image and/or virtual instrumentation and navigation aids, such as radar signatures, the yaw, pitch, and roll readouts, primary flight conditions (including altitude, velocities, headings, etc.), aircraft system status, navigational steering information (e.g., waypoints, flight plans, etc.), automatic and manual flight director cueing, hover data, friendly/enemy (i.e. blue force/red force) position information, targeting data, weapon system status, electronic warfare system status, radio and tactical data communication information (both analog and digital), cabin and ambient pressure readings, emergency communications (warnings, cautions, advisories, etc.), mode and declutter data for the particular underlying image or background currently presented, and other information that may be useful or necessary to operating the rotary aircraft.

In certain existing flight simulation systems, a plurality of independent systems generates the various feeds for the foreground and background images. For example, there may be a foreground generator that generates a simulated foreground image containing virtual instrumentation and contextual data. In some embodiments, these are generated as four separate images for four separate display quadrants. The foreground images may then be superimposed over a background image. In some embodiments, foreground images are multiplexed, such as by an 8-to-4 multiplexer that selects four background quadrants from 8 available inputs. It should be noted that the number of foregrounds and/or backgrounds used is scalable, depending on how many variations are required. At any point in time, the available background inputs can be used in combination with some, all, or none of the available foregrounds. In a particular embodiment, given four static displays requiring four independent foreground inputs and two selectable background inputs, a 6-to-4 multiplexer would be provided.

The background images may also be generated by a plurality of background image generators, such as one for each subsystem. The background images may also be multiplexed or otherwise selected from. The selected foreground and background inputs may then be provided to a video combiner that receives the four selected foreground images and the one selected background image, overlays the foreground images onto the background image, and provides the composite image as a video feed to the simulated MFD.

In existing systems, the video combiner is often a hardware video combiner. The present applicants have found that there are a number of challenges associated with the use of the hardware video combiner. To begin with, hardware video combiners are very expensive. Related to this is their lack of flexibility. As hardware becomes outdated and needs change, it may be expensive to replace one hardware video combiner with another. For example, one display may provide an image at a first resolution, and a second display may provide an image at a second resolution. In many hardware video combiners, it is necessary to use complicated command-line interfaces to configure the video streams to work together. Hardware video combiners also lack flexibility in the types of display outputs that they provide. For example, many modern simulators have the ability to receive inputs via more contemporary interfaces such as QXGA, HDMI, or UHD. On the other hand, the hardware video combiner may provide only legacy interfaces such as VGA or DVI.

Furthermore, many hardware video combiners suffer from a “flicker” effect. The MFD has a number of software defined buttons around its bezel edge. Pressing these buttons controls the content of the display, such as switching between different types of background images, or toggling on or off certain foreground images. In a real aircraft generating actual real-time data, switching between these various signals is nearly instantaneous. However, in a simulator, there is often a pause as the display refreshes. In contemporary systems, the pause is relatively short—on the order of half a second. However, even a short delay may inhibit the virtual reality of the simulator experience. Thus, it is desirable to eliminate such delays.

Modern computer hardware is capable of providing a software video combiner at suitable speeds to provide a more lifelike simulation experience. And because a software video combiner can often be provided on off-the-shelf hardware, the expense of a software video combiner may be substantially less than a hardware video combiner. Furthermore, software video combiners may be more flexible, with the ability to provide a graphical user interface (GUI) for configuration, and the ability to change out interface cards on standard buses such as PCIe.

In an embodiment of the present specification, a software video combiner may include software operating from instructions encoded in a computer readable storage medium that are configured to instruct a processor or other programmable element to provide a software video combiner. In other embodiments, instructions for a software video combiner may be provided in firmware, or the instructions may be encoded directly into a programmable device such as a field-programmable gate array (FPGA) or an application-specific integrated circuit (ASIC).

In an embodiment, the software video combiner may be configured to run on or operate with a graphics processing unit (GPU). By way of example, the software video combiner may generate a foreground image in four quadrants, which may include swaths of non-selected pixels. A non-selected pixel may be of a color that the video card is configured to treat as ignored or transparent. Thus, when the foreground image is overlaid on the background image, the selected pixels of the foreground image appear to be “in front” of the background image. The non-selected pixels, on the other hand, are treated as transparent, so that the background image shows up “behind” the foreground image. This effectively emulates the experience of the actual rotary aircraft, in which the foreground image is actually drawn over the background image. Modern computing systems are capable of creating this effect with very little delay, and in many cases, with no human-perceptible delay.

The following disclosure describes various illustrative embodiments and examples for implementing the features and functionality of the present specification. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time consuming, it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction.

Further, the present disclosure may repeat reference numerals and/or letters in the various examples. This repetition is for the purpose of simplicity and clarity and does not in itself dictate a relationship between the various embodiments and/or configurations discussed.

Example embodiments that may be used to implement the features and functionality of this disclosure will now be described with more particular reference to the attached FIGURES.

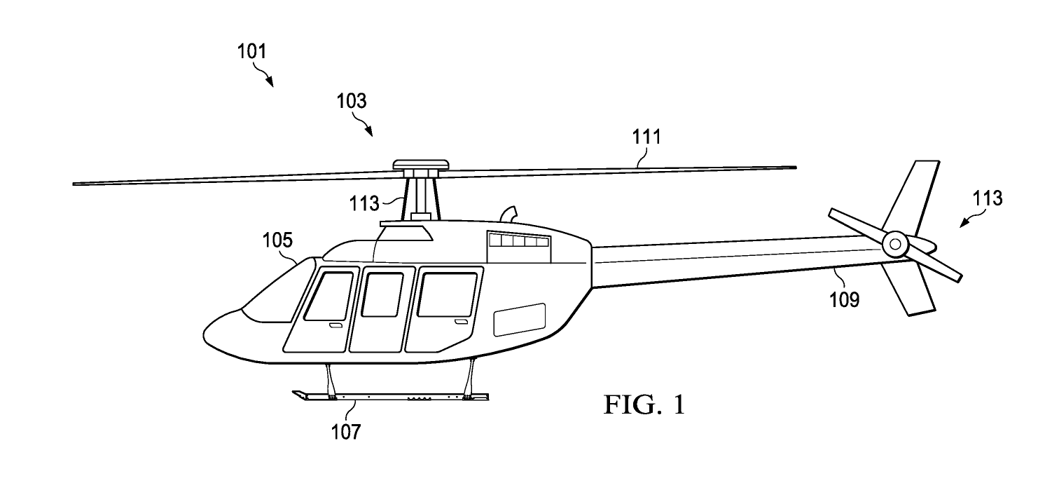

FIG. 1 illustrates an example embodiment of a rotorcraft 100. The illustrated example portrays a side view of rotorcraft 100. Rotorcraft 100 includes a rotor system 102 with a plurality of rotor blades 104. The pitch of each rotor blade 104 can be managed or adjusted in order to selectively control direction, thrust, and lift of rotorcraft 100. Rotorcraft 100 further includes a fuselage 106, tail rotor or anti-torque system 108, an empennage 110, and a tail structure 112. In the illustrated embodiment, tail structure 112 may be used as a horizontal stabilizer. Torque is supplied to rotor system 102 and anti-torque system 108 using at least one engine.

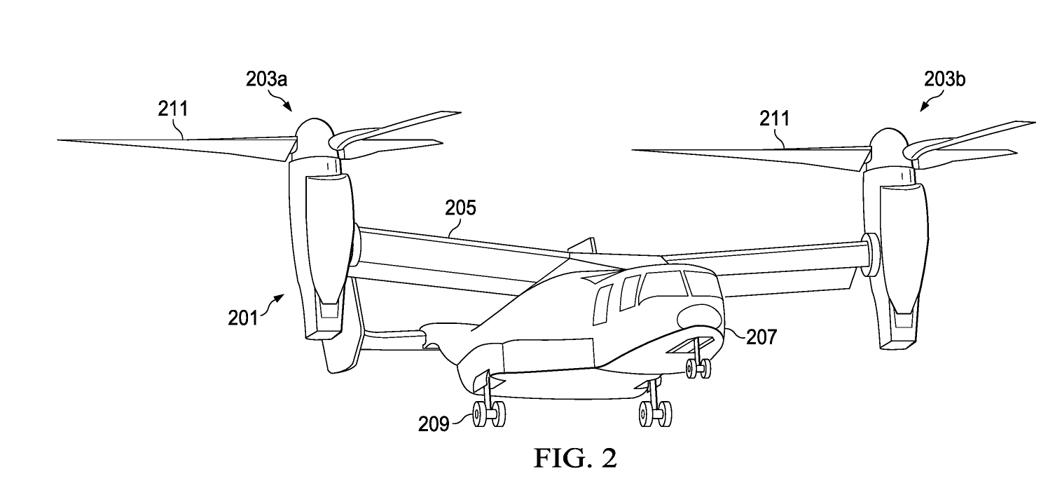

FIG. 2 illustrates a perspective view of an example tiltrotor aircraft 200. Tiltrotor aircraft 200 includes nacelles 203a and 203b, a wing 205, a fuselage 206, and a tail structure 212. Nacelles 203a and 203b respectively include rotor systems 202a and 202b, and each rotor system 202a and 202b includes a plurality of rotor blades 204. Moreover, each nacelle 203a and 203b may include an engine and gearbox for driving rotor systems 202a and 202b, respectively. In some embodiments, nacelles 203a and 203b may each be configured to rotate between a helicopter mode, in which the nacelles 203a and 203b are approximately vertical, and an airplane mode, in which the nacelles 203a and 203b are approximately horizontal. In the illustrated embodiment, tail structure 212 may be used as a vertical stabilizer.

It should be appreciated that rotorcraft 100 of FIG. 1 and tiltrotor aircraft 200 of FIG. 2 are merely illustrative of a variety of aircraft that can be used to implement embodiments of the present disclosure. Other aircraft implementations can include, for example, fixed wing airplanes, hybrid aircraft, unmanned aircraft, gyrocopters, a variety of helicopter configurations, and drones, among other examples. Moreover, it should be appreciated that even though aircraft are particularly well suited to implement embodiments of the present disclosure, the described embodiments can also be implemented using non-aircraft vehicles and devices.

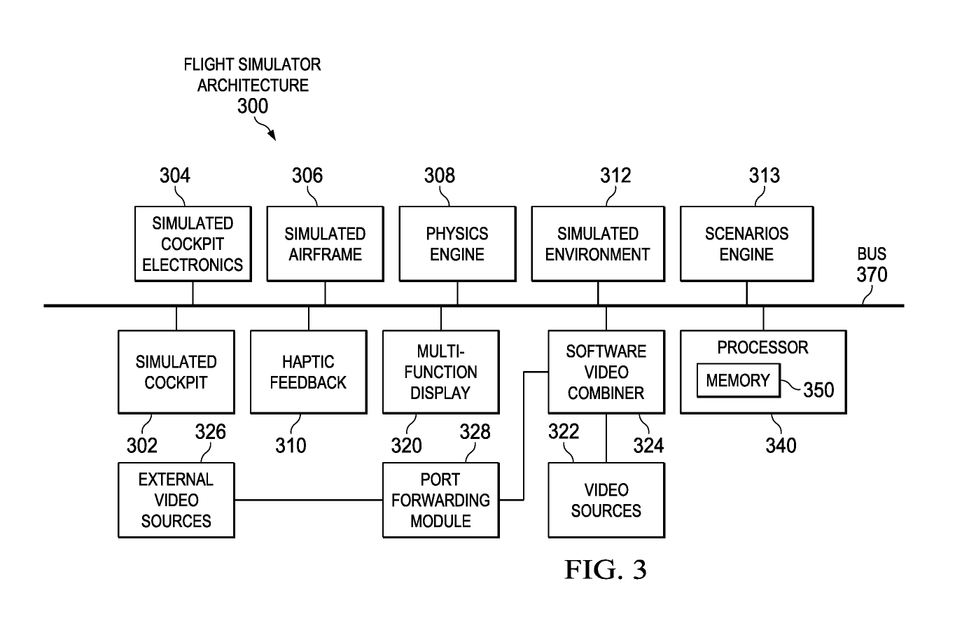

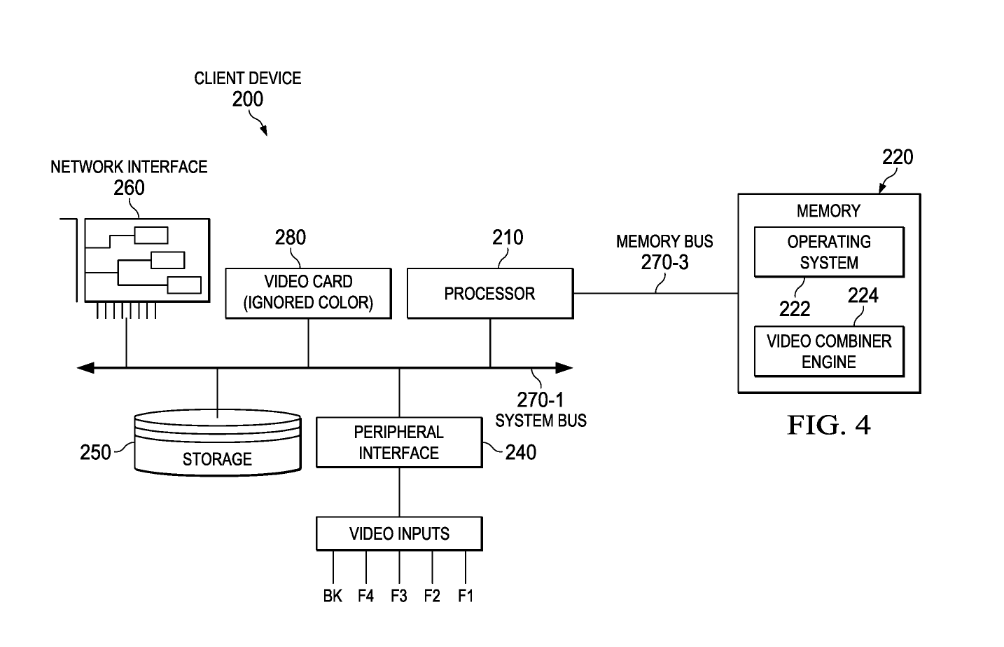

FIG. 3 is a block diagram of a flight simulator architecture according to one or more examples of the present specification. It should be noted that the architecture of FIG. 3 is an example of a relatively full-featured flight simulator which may be found at the higher end of flight simulator options. Unless otherwise noted, inclusion of certain features in flight simulator architecture 300 of FIG. 3 or elsewhere throughout this specification is not intended to imply that those features are necessary to the claims of the present specification. Furthermore, the omission of certain features in FIG. 3 and elsewhere throughout this specification is not intended to imply that such features are incompatible with or should necessarily be excluded from the present claims. Rather, flight simulator architecture 300 of FIG. 3 and other examples throughout this specification are presented earnestly for the purpose of facilitating discussion and enabling a practitioner of the art to adequately understand the teachings of the present specification. In this example, flight simulator architecture 300 includes a bus 370 that may be provided to interconnect various subsystems of flight simulator architecture 300. The term bus 370 should be understood and construed broadly, as described in additional detail in connection with FIG. 4. In a general sense, bus 370 facilitates communication between various subsystems of flight simulator architecture 300.

In this example, flight simulation architecture 300 includes a simulated cockpit 302 and a simulated airframe 306. Simulated cockpit 302 may include a cockpit-like enclosure that provides the instrumentation and features of an actual cockpit. This may include a simulated canopy that displays a simulated forward view, as well as simulated instrumentation readouts.

Simulated airframe 306 may include a platform mounted on pneumatic or hydraulic actuators that simulates the motion of the airframe and provides a flight-like experience.

Haptic feedback 310 may provide simulated roll, tilt, yaw, and other feedback such as simulated vibration. These may be provided in response to both the pilot's action, and in response to simulated ambient conditions, such as air pockets, storms, wind shears, and other environmental challenges. Haptic feedback 310 provides an opportunity for a pilot in training to experience reactions similar to those experienced in a real aircraft.

Physics engine 308 is an engine that provides physics computations that may be inputs to other systems. For example, simulated airframe 306 may move in response to computations from physics engine 308. Simulated cockpit 302 may display on the simulated canopy an image computed in part by physics engine 308. Simulated cockpit electronics 304 may receive input from simulated environment 312, including ambient factors such as temperatures, pressure, wind speed, and other. Based on the simulated environment 312, and using physics engine 308, simulated cockpit electronics 304 may display information that emulates the display that would be provided in an equivalent system in a real rotary aircraft.

Note that one or more processors 340 and memory or memories 350 may provide computational services as necessary to flight simulator architecture 300. Processor 340 and memory 350 are illustrated here as shared resources by way of illustrative example, but in other embodiments, a plurality of processors and memories may provide computing services to various subsystems.

In this example, a multifunction display 320 is driven at least in part by a software video combiner 324. The software video combiner may leverage a shared processor 340 and memory 350, or may be a standalone system with its own processor, memory, and other features. In this case, software video combiner 324 receives video inputs from a plurality of video sources 322. Video sources 322 may include one or more foreground images, such as a four-quadrant foreground image. The video sources 322 may also include a selected background image, or alternately, a plurality of background images that are multiplexed within software video combiner 324. For example, a plurality of video sources may provide a plurality of foreground and background images to software video combiner 324, such as via a plurality of video input interfaces. Software video combiner 324 may include a software multiplexer that selects which video feed or feeds to combine for the MFD display. Software video combiner 324 may also communicate with external video sources 326 via a network, such as an Ethernet, USB, FireWire, or a similar network. In some examples, the external network may be an IP network, and external video sources 326 may provide video to software video combiner 324 via port forwarding module 328.

FIG. 4 is a block diagram of a software video combiner 324 according to one or more examples of the present specification. Note that in the example of FIG. 4, software video combiner 324 is shown as a standalone computing device. The illustration of FIG. 4 does not limit or make reference to how tightly coupled software video combiner 324 is to the rest of the system. Thus it should be understood that software video combiner 324 may be tightly coupled with flight simulation architecture 300, or may be provided externally as a stand-alone device, or even potentially in a data center with sufficiently fast interfaces.

Software combiner device 400 includes a processor 410 connected to a memory 420, having stored therein executable instructions for providing an operating system 422 and at least software portions of a software combiner engine 424. Other components of software combiner device 400 include a storage 450, network interface 460, and peripheral interface 440. This architecture is provided by way of example only, and is intended to be nonexclusive and nonlimiting. Furthermore, the various parts disclosed are intended to be logical divisions only, and need not necessarily represent physically separate hardware and/or software components. Certain computing devices provide main memory 420 and storage 450, for example, in a single physical memory device, and in other cases, memory 420 and/or storage 450 are functionally distributed across many physical devices, such as in the case of a data center storage pool or memory server. In the case of virtual machines or hypervisors, all or part of a function may be provided in the form of software or firmware running over a virtualization layer to provide the disclosed logical function. In other examples, a device such as a network interface 460 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block.

As used throughout this specification, “logic elements” may include hardware (including, for example, a programmable software, application-specific integrated circuit (ASIC), or field-programmable gate array (FPGA)), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, nontransitory computer-readable medium having stored thereon executable instructions for instructing a processor to perform a certain task. Such a nontransitory medium could include, for example, a hard disk, solid state memory or disk, read-only memory (ROM), persistent fast memory (PFM), external storage, redundant array of independent disks (RAID), redundant array of independent nodes (RAIN), network-attached storage (NAS), optical storage, tape drive, backup system, cloud storage, or any combination of the foregoing by way of nonlimiting example. Such a medium could also include instructions programmed into an FPGA, or encoded in hardware on an ASIC or processor.

In an example, processor 410 is communicatively coupled to memory 420 via memory bus 470-3, which may be, for example, a direct memory access (DMA) bus by way of example, though other memory architectures are possible, including ones in which memory 420 communicates with processor 410 via system bus 470-1 or some other bus. In data center environments, memory bus 470-3 may be, or may include, the fabric.

Processor 410 may be communicatively coupled to other devices via a system bus 470-1. As used throughout this specification, a “bus” includes any wired or wireless interconnection line, network, connection, fabric, bundle, single bus, multiple buses, crossbar network, single-stage network, multistage network, or other conduction medium operable to carry data, signals, or power between parts of a computing device, or between computing devices. It should be noted that these uses are disclosed by way of nonlimiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of nonlimiting example a microprocessor, digital signal processor (DSP), field-programmable gate array (FPGA), graphics processing unit (GPU), programmable logic array (PLA), application-specific integrated circuit (ASIC), or virtual machine processor. In certain architectures, a multicore processor may be provided, in which case processor 410 may be treated as only one core of a multicore processor, or may be treated as the entire multicore processor, as appropriate. In some embodiments, one or more coprocessors may also be provided for specialized or support functions.

Processor 410 may be connected to memory 420 in a DMA configuration via bus 470-3. To simplify this disclosure, memory 420 is disclosed as a single logical block, but in a physical embodiment may include one or more blocks of any suitable volatile or nonvolatile memory technology or technologies, including, for example, double data rate random access memory (DDR RAM), static random access memory (SRAM), dynamic random access memory (DRAM), persistent fast memory (PFM), cache, L1 or L2 memory, on-chip memory, registers, flash, read-only memory (ROM), optical media, virtual memory regions, magnetic or tape memory, or similar. Memory 420 may be provided locally, or may be provided elsewhere, such as in the case of a datacenter with a memory server. In certain embodiments, memory 420 may comprise a relatively low-latency volatile main memory, while storage 450 may comprise a relatively higher-latency nonvolatile memory. However, memory 420 and storage 450 need not be physically separate devices, and in some examples may represent simply a logical separation of function. These lines can be particularly blurred in cases where the only long-term memory is a battery-backed RAM, or where the main memory is provided as PFM. It should also be noted that although DMA is disclosed by way of nonlimiting example, DMA is not the only protocol consistent with this specification, and that other memory architectures are available.

Operating system 422 may be provided, though it is not necessary in all embodiments. For example, some embedded systems operate on “bare metal” for purposes of speed, efficiency, and resource preservation. However, in contemporary systems, it is common for even minimalist embedded systems to include some kind of operating system. Where it is provided, operating system 422 may include any appropriate operating system, such as Microsoft Windows, Linux, Android, Mac OSX, Apple iOS, Unix, or similar. Some of the foregoing may be more often used on one type of device than another. For example, desktop computers or engineering workstations may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. Embedded devices often use an embedded Linux or a dedicated embedded OS such as VxWorks. However, these examples are not intended to be limiting.

Storage 450 may be any species of memory 420, or may be a separate nonvolatile memory device. Storage 450 may include one or more nontransitory computer-readable mediums, including, by way of nonlimiting example, a hard drive, solid-state drive, external storage, redundant array of independent disks (RAID), redundant array of independent nodes (RAIN), network-attached storage, optical storage, tape drive, backup system, cloud storage, or any combination of the foregoing. Storage 450 may be, or may include therein, a database or databases or data stored in other configurations, and may include a stored copy of operational software such as operating system 422 and software portions of software combiner engine 424. In some examples, storage 450 may be a nontransitory computer-readable storage medium that includes hardware instructions or logic encoded as processor instructions or on an ASIC. Many other configurations are also possible, and are intended to be encompassed within the broad scope of this specification.

Network interface 460 may be provided to communicatively couple software combiner device 400 to a wired or wireless network. A “network,” as used throughout this specification, may include any communicative platform or medium operable to exchange data or information within or between computing devices, including, by way of nonlimiting example, Ethernet, WiFi, a fabric, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment. Note that in certain embodiments, network interface 460 may be, or may include, a host fabric interface (HFI).

Software combiner engine 424, in one example, is operable to carry out computer-implemented methods as described in this specification. Software combiner engine 424 may include one or more tangible nontransitory computer-readable mediums having stored thereon executable instructions operable to instruct a processor to provide a software combiner engine 424. Software combiner engine 424 may also include a processor, with corresponding memory instructions that instruct the processor to carry out the desired method. As used throughout this specification, an “engine” includes any combination of one or more logic elements, of similar or dissimilar species, operable for and configured to perform one or more methods or functions of the engine. In some cases, software combiner engine 424 may include a special integrated circuit designed to carry out a method or a part thereof, and may also include software instructions operable to instruct a processor to perform the method. In some cases, software combiner engine 424 may run as a “daemon” process. A “daemon” may include any program or series of executable instructions, whether implemented in hardware, software, firmware, or any combination thereof that runs as a background process, a terminate-and-stay resident program, a service, system extension, control panel, bootup procedure, BIOS subroutine, or any similar program that operates without direct user interaction. In certain embodiments, daemon processes may run with elevated privileges in a “driver space” associated with ring 0, 1, or 2 in a protection ring architecture. It should also be noted that software combiner engine 424 may also include other hardware and software, including configuration files, registry entries, and interactive or user-mode software by way of nonlimiting example.

In one example, software combiner engine 424 includes executable instructions stored on a nontransitory medium operable to perform a method according to this specification. At an appropriate time, such as upon booting software combiner device 400 or upon a command from operating system 422, processor 410 may retrieve a copy of the instructions from storage 450 and load it into memory 420. Processor 410 may then iteratively execute the instructions of Software combiner engine 424 to provide the desired method.

Peripheral interface 440 may be configured to receive a plurality of video inputs, such as a background video input, and in some examples four foreground video inputs enumerated as Foreground 1, Foreground 2, Foreground 3, and Foreground 4. Video combiner engine 424 may composite these images by encoding each foreground image with a series of non-selected pixels interrupted by one or more selected pixels. For example, if run-length encoding (RLE) is used, each run length may include a string of non-selected pixels, and one or more selected pixels. Non-selected pixels are assigned a color that video card 480 is configured to ignore. Thus, when foreground images are overlaid on the background image, the background image shows through the series of non-selected pixels.

Note that the non-selected pixel color may be any selected color. Blue and green are popular choices for non-selected pixel colors. However, in a general sense, any color may be selected as the non-selected color. Video card 480 ignores pixels of the non-selected color.

Also note that in this example, the foreground and background images are illustrated as being multiplexed before they reach software video combiner 324. However, this is a nonlimiting example, and in other examples, video feeds may be multiplexed within software video combiner 424, either in hardware or in software.

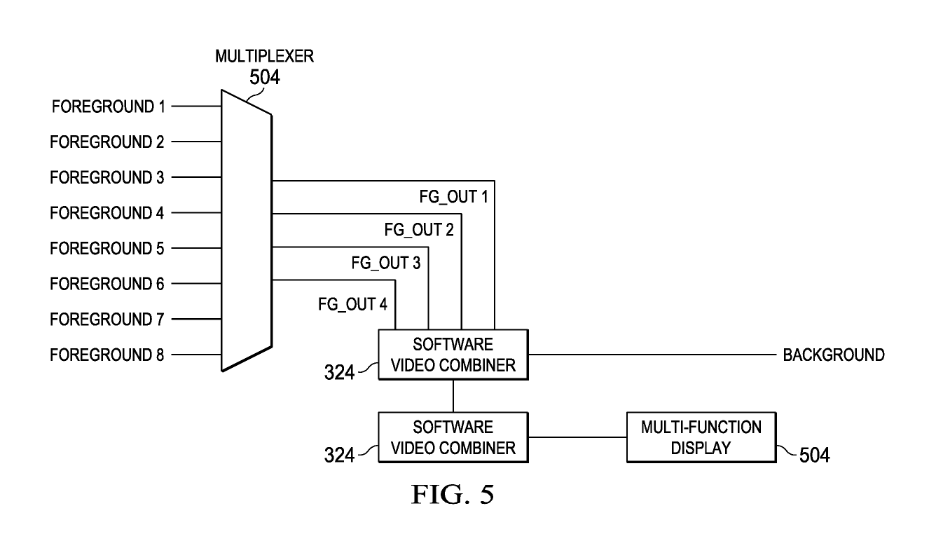

FIG. 5 is a block diagram of a multiplexer 504 according to one or more examples of the present specification. Note that multiplexer 504 may be embodied internal to software video combiner 324, or external to software video combiner 324, and in either case could be either a hardware or software module. For example, in a software multiplexer, a plurality of inputs may be received by a plurality of video input cards, and the software multiplexer may include logic to select a stream to forward to the software video combiner engine.

In this example, multiplexer 504 is an 8-to-4 multiplexer that receives 8 video inputs, and from those selects four video outputs. In this case, the four video outputs are the four quadrants of a foreground display. Note that in generating the foreground images, the foreground image generator may be configured to provide non-selected pixels in a color ignored by video card for 480 of FIG. 4.

Multiplexer 504 outputs FG_OUT1 (foreground output 1), FG_OUT2, FG_OUT3, and FG _OUT4.

In this example, a single background image is provided. This may imply, for example, that the background image is switched at the source, or in other words, the background image generator may be configured to provide only one background image at a time. However, other embodiments are possible, such as an embodiment where a plurality of background images are simultaneously provided, and multiplexed similar to the foreground images.

In this example, the four foreground images are provided to software video combiner 324, along with the background image. Software video combiner then displays the composite image to multifunction display 320.

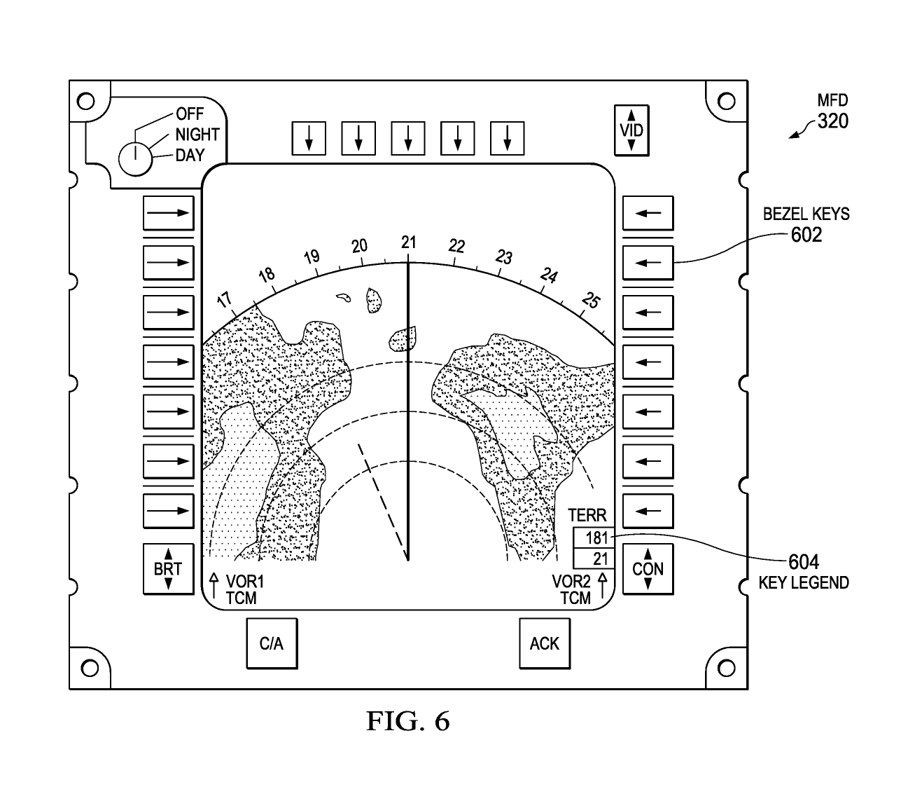

FIG. 6 is a front view of a multifunction display according to one or more examples of the present specification. In this example, MFD 320 includes a plurality of bezel keys 602 which are configured to perform functions such as toggling between different available background displays, or to toggle on or off certain foreground display features.

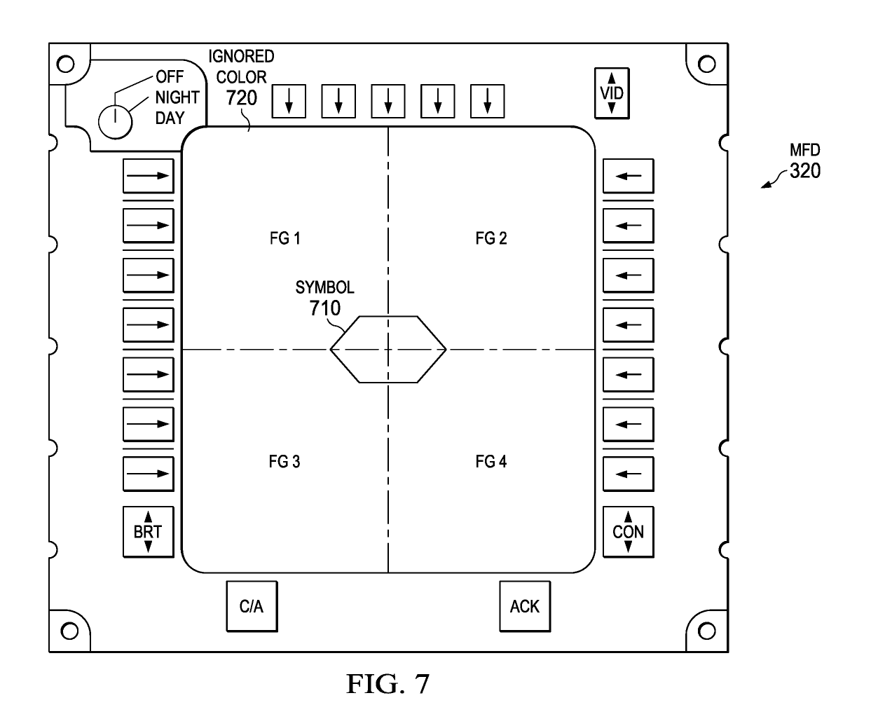

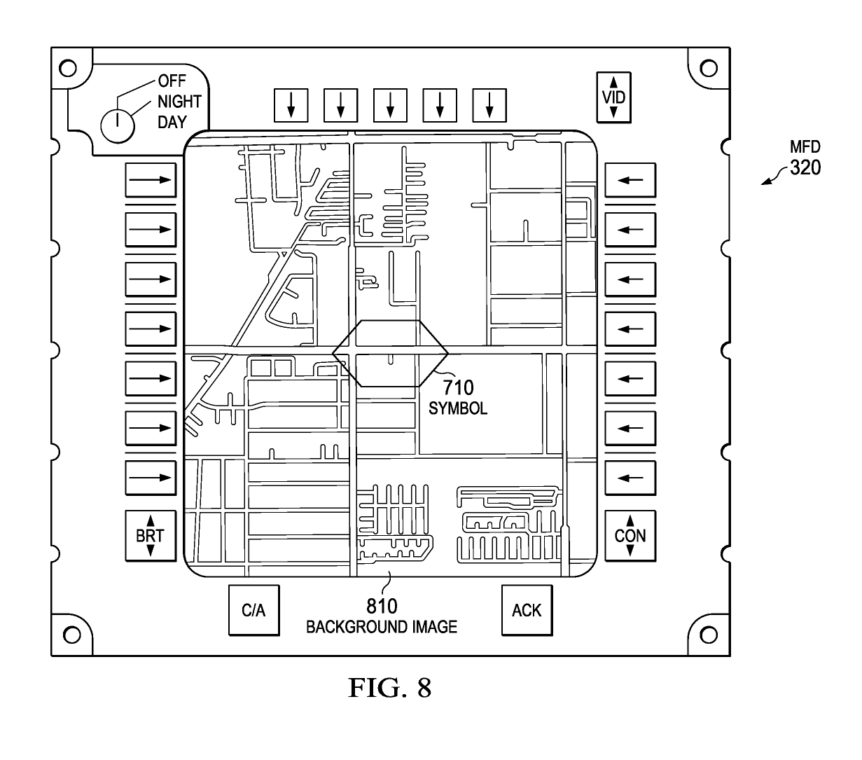

FIG. 7 illustrates that MFD 320 may include a foreground image containing quadrants FG1, FG2, FG3, and FG4. The bulk of each foreground image is made up of ignored color 720. This is a color that video card 480 of FIG. 4 is configured to ignore or treat as transparent. The foreground image also includes one or more symbols 710, which are data that may be displayed as part of the foreground image. In in this case, symbol 710 is made of a color other than ignored color 720. This ensures that while the background image appears behind ignored color 720, symbol 710 appears to be superimposed over the background image. This effect can be seen in FIG. 8, where background image 810 appears in the background as intended, while symbol 710 appears to be superimposed in the foreground as intended.

The embodiments described throughout this disclosure provide numerous technical advantages, including advantages in terms of speed, cost, and flexibility, as described above.

The flowcharts and diagrams in the FIGURES illustrate the architecture, functionality, and operation of possible implementations of various embodiments of the present disclosure. It should also be noted that, in some alternative implementations, the function(s) associated with a particular block may occur out of the order specified in the FIGURES. For example, two blocks shown in succession may, in fact, be executed substantially concurrently, or the blocks may sometimes be executed in the reverse order or alternative orders, depending upon the functionality involved.

Although several embodiments have been illustrated and described in detail, numerous other changes, substitutions, variations, alterations, and/or modifications are possible without departing from the spirit and scope of the present specification, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

In order to assist the United States Patent and Trademark Office (USPTO), and any readers of any patent issued on this application, in interpreting the claims appended hereto, it is noted that: (a) Applicant does not intend any of the appended claims to invoke paragraph (f) of 35 U.S.C. § 112, as it exists on the date of the filing hereof, unless the words “means for” or “steps for” are explicitly used in the particular claims; and (b) Applicant does not intend, by any statement in the specification, to limit this disclosure in any way that is not otherwise expressly reflected in the appended claims.

What is claimed is:

1. A software video combiner, comprising:
a processor;
a memory;
a video input interface;
a video output interface; and
one or more logic elements comprising a software video combiner engine, configured to:
receive a plurality of input images via the video input interface; and
create a composite image from the plurality of input images, comprising overlaying a first image onto a second image, treating pixels of the first image of an ignored color as non-selected pixels, and outputting the composite image to a multifunction display (MFD) via the video output interface.

2. The software video combiner of claim 1, wherein the MFD is an MFD of a flight simulator.

3. The software video combiner of claim 1, wherein the first image is a simulated foreground image for a rotary aircraft MFD.

4. The software video combiner of claim 1, wherein the plurality of input images includes a plurality of simulated foreground images.

5. The software video combiner engine of claim 4, wherein the plurality of simulated foreground images comprise four foreground images representing four quadrants of a foreground image.

6. The software video combiner engine of claim 1, wherein the second image is a background image.

7. The software video combiner engine of claim 1, further comprising a multiplexer to select between a plurality of video inputs to select fewer than all of the plurality of video inputs.

8. One or more tangible, non-transitory computer-readable storage mediums having stored thereon executable instructions for providing a software video combiner engine, comprising:
a processor;
a memory;
a video input interface;
a video output interface;
one or more logic elements comprising a software video combiner, configured to:
receive a plurality of input images via the video input interface; and
create a composite image from the plurality of input images, comprising overlaying a first image onto a second image,
treating pixels of the first image of an ignored color as non-selected pixels, and
outputting the composite image to a multifunction display (MFD) via the video output interface.

9. The one or more tangible, non-transitory computer-readable storage mediums of claim 8, wherein the MFD is an MFD of a flight simulator.

10. The one or more tangible, non-transitory computer-readable storage mediums of claim 8, wherein the first image is a simulated foreground image for a rotary aircraft multifunction display.

11. The one or more tangible, non-transitory computer-readable storage mediums of claim 8, wherein the plurality of input images includes a plurality of simulated foreground images.

12. The one or more tangible, non-transitory computer-readable storage mediums of claim 11, wherein the plurality of simulated foreground images comprises four foreground images representing four quadrants of a foreground image.

13. The one or more tangible, non-transitory computer-readable storage mediums of claim 8, wherein the second image is a background image.

14. The one or more tangible, non-transitory computer-readable storage mediums of claim 8, further comprising a multiplexer to select between a plurality of video inputs to select fewer than all of the plurality of video inputs.

15. A flight simulator for a rotary aircraft, comprising:
a simulated cockpit;
a simulated airframe;
a multifunction display; and
a software video combiner engine, comprising:
a processor;
a memory;
a video input interface;
a video output interface; and
one or more logic elements comprising a software video combiner, configured to:
receive a plurality of input images via the video input interface; and
create a composite image from the plurality of input images, comprising overlaying a first image onto a second image, treating pixels of the first image of an ignored color as non-selected pixels, and outputting the composite image to a multifunction display (MFD) via the video output interface.

16. The flight simulator of claim 15, wherein the first image is a simulated foreground image for a rotary aircraft MFD.

17. The flight simulator of claim 15, wherein the plurality of input images includes a plurality of simulated foreground images.

18. The flight simulator of claim 15, wherein the plurality of input images includes a plurality of simulated foreground images representing four quadrants of a foreground image.

19. The flight simulator of claim 15, wherein the second image is a background image.

20. The flight simulator of claim 15, further comprising a multiplexer to select between a plurality of video inputs to select fewer than all of the plurality of video inputs.
